(19) United States
(12) Patent Application Publication
(10) Pub. No.: US 2014/0334333 A1
(43) Pub. Date: Nov. 13, 2014

(54) METHOD AND APPARATUS FOR DETERMINING DOWNLINK COORDINATED MULTIPOINT MEASUREMENT SET

(71) Applicant: FUJITSU LIMITED, Kawasaki-shi (JP)

(72) Inventors: Yueqiao XU, Beijing (CN); Yuantao ZHANG, Beijing (CN); Yi WANG, Beijing (CN); Hua ZHOU, Beijing (CN)

(73) Assignee: FUJITSU LIMITED, Kawasaki-shi (JP)

(21) Appl. No.: 14/445,625

(22) Filed: Jul. 29, 2014

Related U.S. Application Data
(63) Continuation of application No. PCT/CN2012/070898, filed on Feb. 6, 2012.

(51) Int. Cl. H04W 72/04; H04W 24/10

(52) U.S. Cl. CPC H04W 72/0406; H04W 24/10
USPC 370/252

(57) ABSTRACT

A method and apparatus for determining a downlink coordinated multipoint measurement set. The method includes: receiving reference signal receiving power of a channel state information reference signal transmitted by each point in an RRM measurement set reported by UE; wherein the reference signal receiving power of each point in the RRM measurement set is measured by the UE based on more than one groups of preconfigured channel state information reference signal resources; and determining the downlink coordinated multipoint measurement set according to the reference signal receiving power reported by the UE. With the method, the UE needs not to measure RSRP of all the points for transmitting signals, thereby avoiding waste of resources, and solving problems in the prior art.

### CROSS-REFERENCE TO RELATED APPLICATIONS

This is a continuation of International Application No. PCT/CN2012/070898, filed on Feb. 6, 2012, now pending, the contents of which are herein wholly incorporated by reference.

### TECHNICAL FIELD

The present application relates to the field of communications, and in particular to a method and apparatus for determining a downlink coordinated multipoint measurement set.

### BACKGROUND

In a long-term evolution (LTE) system, coordinated multipoint (CoMP) transmission/receiving is brought into an LTE-A system as one of key technologies. In a coordinated transmission scenario, geographically neighboring transmission points coordinately transmit signals to user equipment (UE), which may improve signal quality and expand coverage especially for a cell-edge user.

In TR36.819, a CoMP measurement set and a radio resource management (RRM) measurement set are defined for downlink CoMP; wherein, the CoMP measurement set refers to a set of points needing to measure a channel state/statistical information, and the RRM measurement set refers to a set of cells measuring RRM (which is identical to the existing Rel-8). And at the same time, other RRM measurement methods may also be taken into account, so as to differentiate different points in the same cell scenario, or to be used for selecting a CoMP measurement set.

However, in the implementation of the present application, the inventors found that the UE cannot differentiate the points according to RRM measurement of a cell-specific reference signal (CRS), and especially for CoMP UE, cannot determine a set of points needing to measure channel state information (CSI) of its downlink CoMP, i.e. a downlink CoMP measurement set, such as in a CoMP scenario 4.

FIG. 1 is a schematic diagram of a typical CoMP scenario 4. As shown in FIG. 1, in a CoMP scenario 4, all the points, including a macro base station (such as a Macro eNB) of relatively large transmission power and remote radio heads (RRHs) of relatively small transmission power, share cell ID. As transmission of downlink CRSs is from all the points, reference signal receiving power (RSRP) measured by the UE based on conventional CRSs is a sum of arriving power of the CRSs transmitted by all the points. The UE cannot differentiate the points according to CRS RRM measurement, and especially for CoMP UE, cannot determine a set of points needing to measure CSI of its downlink CoMP, i.e. a downlink CoMP measurement set. Another RRM measurement method is needed in determining a CoMP measurement set.

### SUMMARY

An object of embodiments of the present application is to provide a method and apparatus for determining a downlink coordinated multipoint measurement set. With the method, the UE needs not to measure RSRP of signals transmitted by all the points, and measures RSRP of a CSI-RS transmitted by each point in an RRM measurement set, thereby saving energy, and avoiding waste of resources.

According to an aspect of the embodiments of the present application, there is provided a method for determining a downlink coordinated multipoint measurement set, including:

receiving reference signal receiving power of a channel state information reference signal (CSI-RS) transmitted by each point in a radio resource management (RRM) measurement set reported by UE; wherein the reference signal receiving power of each point in the RRM measurement set is measured by the UE based on more than one groups of preconfigured channel state information reference signal resources; and determining a downlink coordinated multipoint measurement set according to the reference signal receiving power reported by the UE.

According to another aspect of the embodiments of the present application, there is provided an apparatus for determining a downlink coordinated multipoint measurement set, including:

a receiving unit configured to receive reference signal receiving power of a channel state information reference signal transmitted by each point in a radio resource management (RRM) measurement set reported by UE; wherein the reference signal receiving power of each point in the RRM measurement set is measured by the UE based on more than one groups of preconfigured channel state information reference signal resources; and

a processing unit configured to determine a downlink coordinated multipoint measurement set according to the reference signal receiving power reported by the UE.

According to still anther aspect of the embodiments of the present application, there is provided a method for determining a downlink coordinated multipoint measurement set, including:

measuring, by UE based on more than one groups of preconfigured channel state information reference signal resources, reference signal receiving power of a channel state information reference signal transmitted by each point in an RRM measurement set; and

reporting the measured reference signal receiving power to a primary serving base station.

According to still another aspect of the embodiments of the present application, there is provided an apparatus for determining a downlink coordinated multipoint measurement set, including:

a measuring unit configured to measure reference signal receiving power of a channel state information reference signal transmitted by each point in an RRM measurement set, via more than one groups of preconfigured channel state information reference signal resources, based on a channel state information reference signal; and

a reporting unit configured to report the measured reference signal receiving power to a primary serving base station.

According to still another aspect of the embodiments of the present application, there is provided a computer-readable program, wherein when the program is executed in an apparatus for determining a downlink coordinated multipoint measurement set, the program enables a computer to carry out the method for determining a downlink coordinated multipoint measurement set as described above in the apparatus for determining a downlink coordinated multipoint measurement set.

According to still another aspect of the embodiments of the present application, there is provided a storage medium in which a computer-readable program is stored, wherein the computer-readable program enables a computer to carry out the method for determining a downlink coordinated multipoint measurement set as described above in an apparatus for determining a downlink coordinated multipoint measurement set.

The advantages of the embodiments of the present application reside in that based on multiple groups of preconfigured CSI-RS resources, the UE needs not to measure RSRP of signals by transmitted by all the points, and measures RSRP of a CSI-RS by transmitted by each point in an RRM measurement set, thereby saving energy, and avoiding waste of resources; and the primary serving base station may determine a downlink CoMP measurement set according to RSRP after obtaining the reported RSRP, that is, to determine points needing to measure a channel state/statistical information.

With reference to the following description and drawings, the particular embodiments of the present application are disclosed in detail, and the principle of the present application and the manners of use are indicated. It should be understood that the scope of the embodiments of the present application is not limited thereto. The embodiments of the present application contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

The above and other objects, features and advantages of the present application will be apparent from the following detailed description in conjunction with the drawings, in which:

FIG. 1 is a schematic diagram of a typical CoMP scenario 4;

FIG. 2 is a flowchart of the method for determining a downlink coordinated multipoint measurement set of Embodiment 1 of the present application;

FIG. 3 is a flowchart of the method for determining a downlink coordinated multipoint measurement set of Embodiment 2 of the present application;

FIG. 4 is a schematic diagram of a pattern of resource elements occupied by a CSI-RS of an embodiment of the present application in which different RRH points employs two differently configured ports;

FIG. 5 is a schematic diagram of the structure of the bitmap signaling of an embodiment of the present application;

FIG. 6 is a flowchart of the method for determining a downlink coordinated multipoint measurement set of Embodiment 3 of the present application;

FIG. 7 is a flowchart of the method for determining a downlink coordinated multipoint measurement set of Embodiment 4 of the present application;

FIG. 8 is a schematic diagram of the structure of the apparatus for determining a downlink coordinated multipoint measurement set of Embodiment 5 of the present application;

FIG. 9 is a schematic diagram of the structure of the apparatus for determining a downlink coordinated multipoint measurement set of Embodiment 6 of the present application; and

FIG. 10 is a schematic diagram of the structure of the apparatus for determining a downlink coordinated multipoint measurement set of Embodiment 7 of the present application.

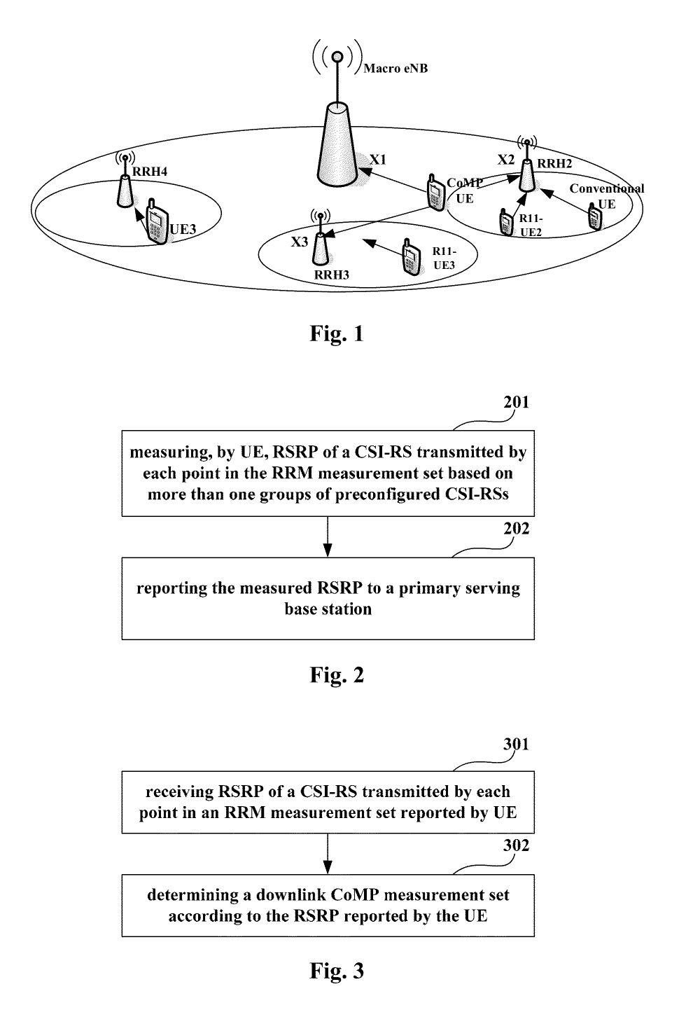

### DETAILED DESCRIPTION

Various embodiments of the present application shall be described below with reference to the accompanying drawings. These embodiments are illustrative only and are not intended to limit the present application. For easy understanding of the principle and embodiments of the present application by those skilled in the art, the embodiments of the present application shall be described taking a method for determining a downlink CoMP measurement set in an LTE-A system as an example. However, it should be understood that the present application is not limited thereto, and is applicable to other systems related to determination of a downlink CoMP measurement set.

For a CoMP scenario 4, in a standard conference of an existing Rel-11, a corresponding method for determining a CoMP measurement set has been proposed, such as uplink signal measurement or determining a CoMP measurement set by using a CQI report.

For a measurement method for an uplink signal, such as a sounding reference signal (SRS), all transmission points need to monitor uplink signals of all potential users and measure arriving power of the uplink signals, so as to judge distances from the points to the users, and determine downlink CoMP measurement sets of the CoMP users. However, a defect exists in such a method that in order to receive uplink signals of the potential users, the points have to reserve corresponding uplink resources for the users, which is prone to waste of uplink resources. Furthermore, a method based on uplink signal measurement is less robust in a heterogeneous network scenario. This is because that in a heterogeneous network scenario, the magnitudes of downlink transmission power of a macro eNB point and an RRH point are different, and even though an eNB far from the UE but having high transmission power may be a point in a downlink (DL) CoMP measurement set, and CSI between the eNB and a user needs to be measured. And as for measurement based on an uplink signal, as the distance is relatively large, it is possible that the macro eNB does not detect the uplink signal of the user.

As for a method for reporting channel quality indication (CQI), the UE needs to measure and report CSI of all possible CoMP transmission points, which is prone to resulting in high complexity of measurement processing and uplink CSI feedback overhead.

It can be seen from above that there still exist problems in these two methods for determining a CoMP measurement set. Therefore, a method for determining a CoMP measurement set is provided in the embodiments of the present application, in which by configuring UE with multiple groups of CSI-RS resources for RRM measurement of points in an RRM measurement set, such as measurement of RPRS of a CSI-RS transmitted by each point in an RRM measurement set (i.e. RSRP measured based on a CSI-RS), the UE report the RPRS of the CSI-RS transmitted by each point in the RRM measurement set, and the eNB determines a downlink CoMP measurement set according to the RSRP reported by the UE, thereby solving the problems existed in the prior art. Furthermore, after determining the downlink CoMP measurement set, the eNB may configure the UE with multiple groups of CSI-RS resources for CSI measurement.

Embodiments of the present application shall be described below with reference to the accompanying drawings.

FIG. 2 is a flowchart of the method for determining a downlink coordinated multipoint measurement set of Embodiment 1 of the present application. At a UE side, the method includes:

step 201: performing RRM measurement on each point in an RRM measurement set by UE based on a CSI-RS via more than one groups of preconfigured CSI-RSs, such as measuring RSRP of a CSI-RS transmitted by each point in the RRM measurement set; and

step 202: reporting the measured RSRP to a primary serving base station.

It can be seen from the above embodiment that the UE needs not to measure RSRP of signals transmitted by all points, but measures RSRP of a CSI-RS transmitted by each point in the RRM measurement set, thereby saving energy and avoiding waste of resources; and the primary serving base station may determine a downlink CoMP measurement set according to the RSRP after obtaining the reported RSRP, that is, to determine points needing to measure a channel state/statistical information.

FIG. 3 is a flowchart of the method for determining a downlink coordinated multipoint measurement set of Embodiment 2 of the present application. At a network side, as shown in FIG. 3, the method includes:

step 301: receiving RSRP of a CSI-RS transmitted by each point in an RRM measurement set reported by UE; wherein the RSRP of a CSI-RS transmitted by each point in the RRM measurement set is measured by the UE based on a CSI-RS via more than one groups of preconfigured CSI-RS resources; and

step 302: determining a downlink CoMP measurement set according to the RSRP reported by the UE.

In this embodiment, any manner in the prior art may be used to determine the downlink CoMP measurement set. For example, at the network side, the primary serving base station (eNB) of the UE brings points satisfying the following inequation into the downlink CoMP measurement set according to the RSRP reported by the UE and following an RSRP threshold rule, that is, for a random point i in the RRM measurement set, if that an absolute value of a difference between RSRP (RSRP_{serving}) of a CSI-RS to which a point of most intense power corresponds and RSRP (RSRPᵢ) of a CSI-RS to which the random point i corresponds is less than a threshold value (Threshold) is satisfied, it is determined that the random point i belongs to the CoMP measurement set. The inequation may be expressed as:

|RSRP_{serving}−RSRPᵢ|<Threshold; where, RSRP_{serving} denotes the RSRP of the CSI-RS to which the point of most intense power corresponds, RSRPᵢ denotes the RSRP of the CSI-RS to which an i-th point in the RRM measurement set corresponds, and Threshold denotes a threshold, i being a positive integer.

It can be seen from the above embodiment that the network side, such as the primary serving base station (eNB) of the UE, may determine a CoMP measurement set according to the RSRP after obtaining the RSRP reported by the UE, and the UE needs not to measure RSRP of signals transmitted by all points, thereby avoiding waste of resources and solving problems in the prior art.

In this embodiment, before the network side, such as the primary serving base station (eNB) of the UE, receives the RSRP reported by the UE, the method further includes: configuring the UE with more than one groups of CSI-RS resources for measuring the RSRP of a CSI-RS transmitted by each point in the RRM measurement set (for simplicity of description, the configured resources are referred to as CSI-RS resources of RRM measurement); and notifying the configured CSI-RS resources to the UE.

In this embodiment, parameters of the configured CSI-RS resources for measuring the RSRP of a CSI-RS transmitted by each point in the RRM measurement set may be relatively few. For example, as the UE needs only to measure the RSRP of a CSI-RS transmitted by each point in the RRM measurement set, it needs not to learn a power ratio P_{c} of energy per-resource element of a physical downlink shared channel (PDSCH EPRE) to energy per-resource element of the channel state information reference signal (CSI-RS EPRE). Therefore, the parameters of the configured CSI-RS resources may not include the power ratio P_{c}.

In this embodiment, the parameters of the configured CSI-RS resources for measuring the RSRP of a CSI-RS transmitted by each point in the RRM measurement set include one or more of the following parameters:

1) the number of antenna ports; wherein, the number of CSI-RS ports for measuring the RSRP of a CSI-RS transmitted by each point in the RRM measurement set may be fixed; for example, similar to that port 0 of a CRS is always employed in the prior art, a fixed number of ports are employed, such as 2 or 4;

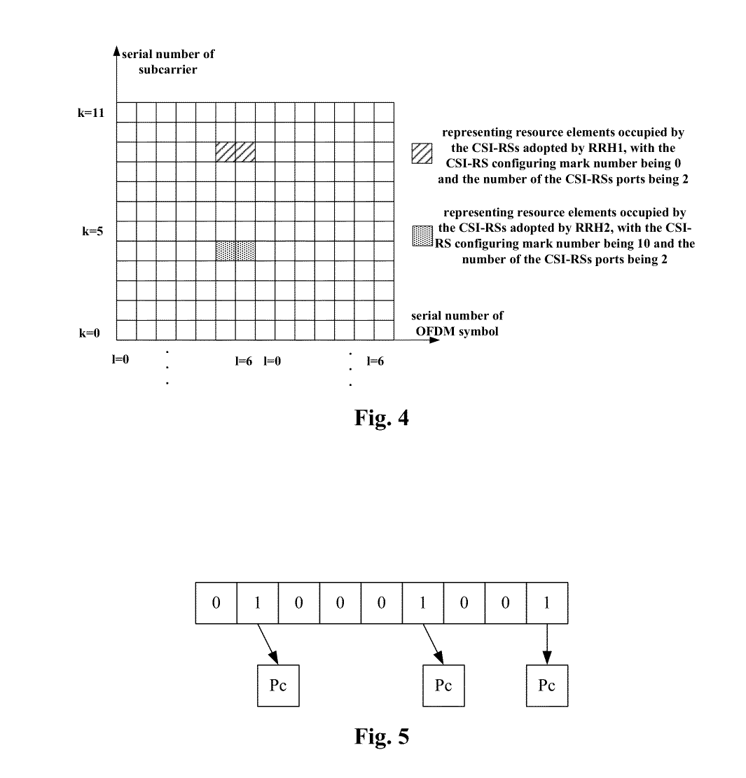

2) a CSI-RS configuring parameter, i.e., a configuring parameter used for determining resource elements (REs) occupied by CSI-RS, that is, a patter used for determining resource elements occupied by CSI-RS; as shown in FIG. 4, RRH1 transmits CSI-RSs of two ports, with their CSI-RS configuring parameters being 0, and RRH2 transmits CSI-RSs of two ports, with their CSI-RS configuring parameters being 10; according to the 36.211 standard, a schematic diagram of the resource elements occupied by the CSI-RSs transmitted by RRH1 and RRH2 is shown in FIG. 4; in this way, the UE may differentiate the CSI-RSs of the two ports according to the pattern; as shown in FIG. 4, l denotes a serial number of an OFDM symbol in a resource block (RB), and k denotes a serial number of a subcarrier in an RB; and

3) a CSI-RS subframe configuring parameter, including a CSI-RS periodicity for transmitting a CSI-RS and a subframe offset, which decide a time for transmitting a CSI-RS, that is, deciding a subframe where the CSI-RS is located.

In this embodiment, after determining the downlink CoMP measurement set, the method further includes: configuring the UE with more than one groups of CSI-RS resources for measuring CSI (i.e. CSI-RS resources for CSI measurement); and notifying the configured CSI-RS resources for measuring CSI to the UE.

In an embodiment, the CSI-RS resources for the CSI measurement and the CSI-RS resources for the RRM measurement may be configured independently, that is, the CSI-RS resources for measuring the CSI and the CSI-RS resources for the RRM measurement are different. Namely, even though a point belongs to both the RRM measurement set and the CoMP measurement set, it will transmit a group of CSI-RS resources for RRM measurement, and will also transmit another group of CSI-RS resources for CSI measurement.

In the existing LTE-R10 standard, the parameters needing to be configured for the CSI-RS resources for measuring the CSI are as follows:

1) the number of CSI-RS ports, {2, 4, 8};

2) a CSI-RS configuration, that is, a patter used for determining resource elements (REs) occupied by CSI-RS;

3) CSI-RS subframe configuration, including a CSI-RS periodicity for transmitting a CSI-RS and a subframe offset, which decide a time for transmitting a CSI-RS; and

4) Pc, denoting a power ratio of PDSCH EPRE (physical downlink shared channel energy per-resource element) to CSI-RS EPRE.

In this embodiment, the parameters of the configured CSI-RS resources for CSI measurement include one or more of the following parameters:

1) the number of CSI-RS ports; for example, the number of ports transmitting CSI-RSs may be any one of {2, 4, 8};

2) a CSI-RS configuring parameter, i.e., a configuring parameter used for determining resource elements occupied by CSI-RS; for example, a pattern used for determining the resource elements occupied by CSI-RS;

3) CSI-RS subframe configuring parameter, including a CSI-RS periodicity for transmitting a CSI-RS and a subframe offset, which decide a time for transmitting a CSI-RS, that is, deciding a subframe where the CSI-RS is located; and

4) P_{c}, a power ratio of PDSCH EPRE to CSI-RS EPRE.

In another embodiment, the CSI-RS resources for measuring the CSI are not configured independently. In particular, the CSI-RS resources for measuring the CSI are selected from the CSI-RS resources for measuring the RRM.

In this embodiment, after the CSI-RS resources for the CSI measurement are selected, the selected CSI-RS resources for the CSI measurement are notified to the UE via signaling, such as semi-statically configured radio resource control (RRC) signaling, or dynamic downlink control information (DCI). For example, which of the resources in the CSI-RS resources for the RRM measurement are used for CSI measurement may be notified via bitmap signaling carried by high-layer RRC signaling; furthermore, the parameters of the CSI-RS resources for the CSI measurement may be notified to the UE via bitmap signaling.

FIG. 5 is a schematic diagram of the bitmap signaling. For example, a bitmap of a link structure is used to indicate which of the resources in the CSI-RS resources for the RRM measurement are used for CSI measurement. As shown in FIG. 5, the network side configures the UE with 9 groups of CSI-RS resources for the RRM measurement, and the CSI-RS resources for the CSI measurement are selected from the 9 groups of CSI-RS resources for the RRM measurement. As shown in FIG. 5, three groups of resources are selected for CSI measurement; for example, bit “1” denotes CSI-RS resources for CSI measurement, and the CSI-RS resources not selected for CSI measurement are denoted by bit “0”, thereby notifying the UE via the bitmap signaling of which resources are used for CSI measurement.

In this case, the parameter P_{c} for CSI measurement needs to be configured; and at the same time of notifying the resources to the UE, the signaling may further notify the UE of related parameters, such as the parameter P_{c}, as shown in FIG. 5.

Other parameters, such as the number of antenna ports, the CSI-RS configuring parameter and the CSI-RS subframe configuring parameter, may all be reused as the parameters of the CSI-RS resources for the RRM measurement. And these parameters may also be reconfigured. In case of reconfiguring these parameters, at the same time of notifying the resources to the UE, the signaling may further notify the UE of related parameters, such as the parameter P_{c}, the number of antenna ports, the CSI-RS configuring parameter and the subframe configuring parameter.

It can be seen from the above embodiment that the UE needs not to measure RSRP of a signal transmitted by all points, but measures RSRP of a CSI-RS transmitted by each point in the RRM measurement set, thereby saving energy and avoiding waste of resources; and the primary serving base station of the UE may determine a downlink CoMP measurement set according to the RSRP after obtaining the reported RSRP, that is, selecting the points of the CoMP measurement set from the RRM measurement set, thereby solving the problems existed in the prior art.

The method for determining a CoMP measurement set of an embodiment of the present application shall be described below with reference to the accompanying drawings.

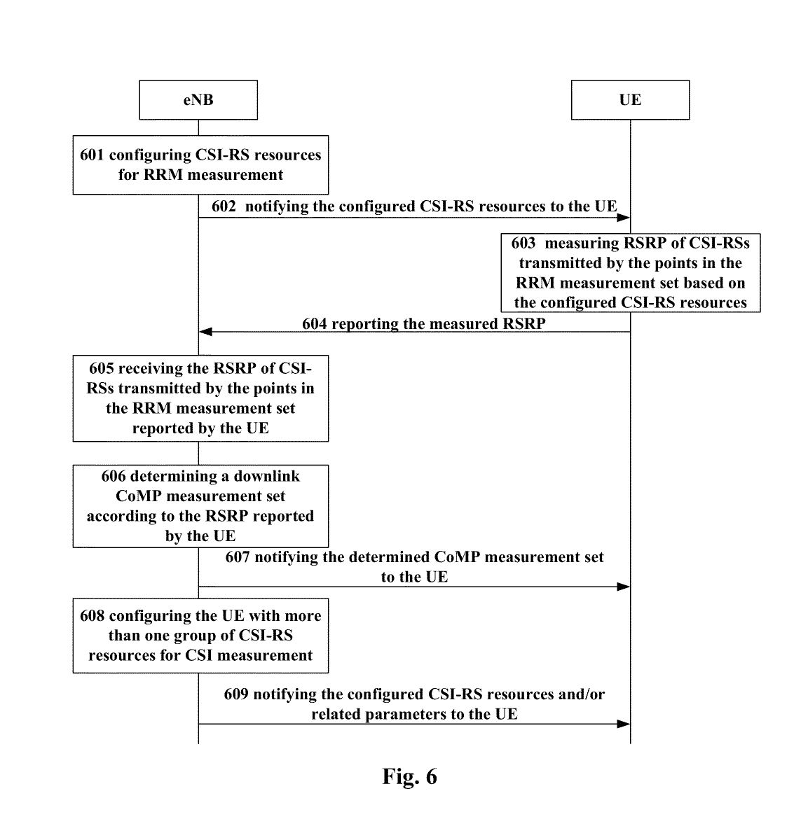

FIG. 6 is a flowchart of the method for determining a downlink CoMP measurement set of Embodiment 3 of the present application, which is described taking independently configuring CSI-RS resources for RRM measurement as an example. As shown in FIG. 6, the method includes:

step 601: configuring multiple groups of CSI-RS resources of RRM measurement set (i.e. resources for RRM measurement) by a network side, such the primary serving base station (eNB) of the UE;

wherein, parameters of the CSI-RS resources for RRM measurement may not include the parameter P_{c}, and may include the following parameters: the number of antenna ports, the CSI-RS configuring parameter and the subframe configuring parameter; and wherein, details of each parameter are as described in embodiments 1 and 2, which shall not be described herein any further;

step 602: notifying the configured CSI-RS resources for RRM measurement by the eNB to the UE;

step 603: measuring RSRP of CSI-RSs transmitted by the points in the RRM measurement set via the CSI-RS resources based on a CSI-RS after the UE receives the notification;

step 604: reporting the measured RSRP to the primary serving base station (eNB);

step 605: receiving the RSRP of CSI-RSs transmitted by the points in the RRM measurement set reported by the UE;

step 606: determining a downlink CoMP measurement set according to the RSRP reported by the UE;

wherein, a manner of determining the downlink CoMP measurement set may follow a threshold rule, which is as described in Embodiment 2, and shall not be described herein any further; in this way, the points in the CoMP measurement set may be determined from the RRM measurement set;

step 607: notifying the determined CoMP measurement set by the eNB to the UE;

step 608: configuring the UE with one or more groups of CSI-RS resources for CSI measurement by the eNB;

in this embodiment, the CSI-RS resources for the CSI measurement may be configured independently, that is, the CSI-RS resources for the CSI measurement and the CSI-RS resources for the RRM measurement are different;

wherein, the parameters of the CSI-RS resources for the CSI measurement are as described in embodiments 1 and 2, which shall not be described herein any further;

step 609: notifying the configured CSI-RS resources for the CSI measurement, or further related resource parameters, to the UE.

The method shown in FIG. 6 is just an embodiment of the present application, in which some steps may be interchanged or combined; for example, the execution orders of steps 607 and 608 may be interchanged, and steps 607 and 609 may be combined and executed simultaneously, etc.

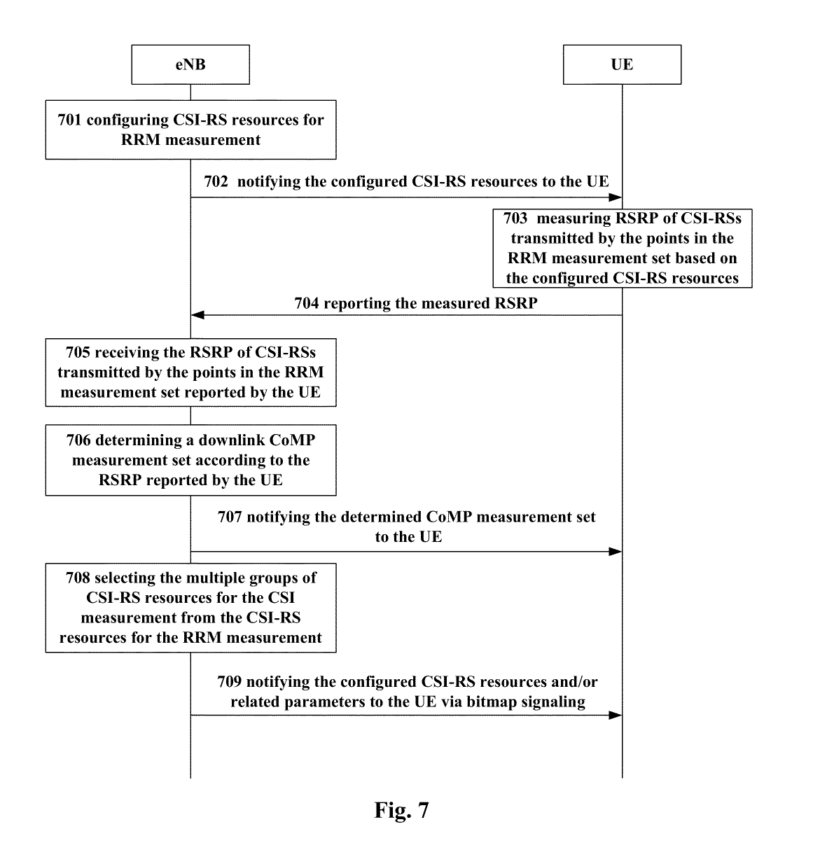

FIG. 7 is a flowchart of the method for determining a downlink CoMP measurement set of Embodiment 4 of the present application, which is described taking not independently configuring CSI-RS resources for RRM measurement as an example. As shown in FIG. 7, the method includes:

steps 701 to 707 are similar to steps 601 to 607 in Embodiment 3, which shall not be described herein any further;

step 708: configuring the UE with one or more groups of CSI-RS resources for CSI measurement; wherein, the multiple groups of CSI-RS resources for the CSI measurement may be selected from the CSI-RS resources for the RRM measurement, and are not configured independently; as shown in FIG. 5, three groups of resources for CSI measurement are selected from the 9 groups of CSI-RS resources for the RRM measurement, the resource parameters being as described in the above embodiments, which shall not be described herein any further;

step 709: notifying the configured CSI-RS resources for the CSI measurement, or further related resource parameters, to the UE; wherein, which of the CSI-RS resources in the resources configured in step 701 are used for the CSI measurement is notified to the UE via bitmap signaling, that is, indicating the UE to select a downlink CoMP measurement set from the RRM measurement set; as shown in FIG. 5, the bitmap signaling may further include parameters of the CSI-RS resources for the CSI measurement, such as the parameter P_{c}, or may further include one or more of the following parameters: the number of antenna ports, the CSI-RS configuring parameter and the subframe configuring parameter.

It can be seen from the above embodiment that the UE needs not to measure RSRP of a signal transmitted by all points, but measures RSRP of a CSI-RS transmitted by each point in the RRM measurement set, thereby saving energy and avoiding waste of resources; and the primary serving base station of the UE may determine a downlink CoMP measurement set according to the RSRP after obtaining the reported RSRP, that is, selecting the points in the CoMP measurement set from the RRM measurement set, thereby solving the problems existed in the prior art.

Furthermore, the CSI-RS resources for the CSI measurement and the CSI-RS resources for the RRM measurement may be configured independently, and the CSI-RS resources for measuring the CSI may be selected from the CSI-RS resources for the RRM measurement; and parameters of the configured CSI-RS resources for the RRM measurement are relatively few; furthermore, the network side may notify the configured resources and related parameters to the UE via bitmap signaling.

A person of ordinary skill in the art may understand that all or part of the steps in the method carrying out the above embodiment may be carried out by related hardware instructed by a program. The program may be stored in a computer-readable storage medium. And when being executed, the program may include all or part of the steps in the method in the above embodiment, and the storage medium may include an ROM, an RAM, a floppy disc, and a compact disc, etc.

An embodiment of the present application further provides an apparatus for determining a downlink coordinated multipoint measurement set, as described in the embodiment below. As the principle of the apparatus for determining a downlink coordinated multipoint measurement set for solving problems is similar to that of the above method for determining a downlink coordinated multipoint measurement set, the implementation of the method may be referred to for the implementation of the apparatus for determining a downlink coordinated multipoint measurement set, and the repeated parts shall not be described any further.

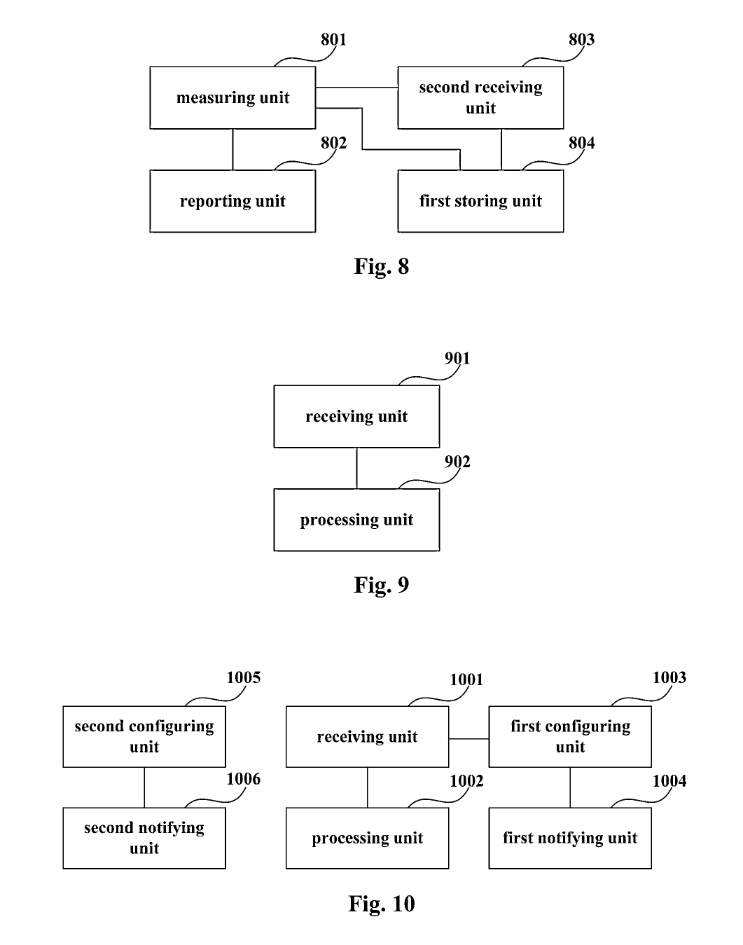

FIG. 8 shows the apparatus for determining a downlink coordinated multipoint measurement set of Embodiment 5 of the present application. The apparatus is UE, which includes: a measuring unit 801 and a reporting unit 802; wherein,

the measuring unit 801 is configured to measure RSRP of a CSI-RS transmitted by each point in an RRM measurement set, based on more than one groups of preconfigured CSI-RS resources; wherein, a detailed method of measurement is as described in step 201, which shall not be described herein any further;

and the reporting unit 802 is configured to report the measured RSRP to a network side, such as a primary serving base station.

In this embodiment, the apparatus further includes a second receiving unit 803 configured to receive more than one groups of configured CSI-RS resources for measuring the reference signal receiving power of a CSI-RS transmitted by each point in the RRM measurement set, and/or corresponding parameters, notified by the network side, or to receive one or more groups of configured CSI-RS resources for CSI measurement, and/or corresponding parameters, notified by the network side.

Furthermore, the apparatus may include a first storing unit 804 configured to store the above resources and corresponding parameters notified by the network side, for use by the measuring unit 801 in performing measurement.

FIG. 9 is a schematic diagram of the structure of the apparatus for determining a downlink coordinated multipoint measurement set of Embodiment 6 of the present application. The apparatus may be a base station serving for UE, that is, a primary serving base station (eNB). As shown in FIG. 9, the apparatus includes: a receiving unit 901 and a processing unit 902; wherein,

the receiving unit 901 is configured to receive reference signal receiving power of a CSI-RS transmitted by each point in an RRM measurement set reported by UE; wherein the reference signal receiving power of a CSI-RS transmitted by each point in the RRM measurement set is measured by the UE based on CSI-RS, using more than one groups of preconfigured channel state information reference signal (CSI-RS) resources;

and the processing unit 902 is configured to determine a downlink CoMP measurement set according to the RSRP reported by the UE; wherein, a manner of processing of the processing unit 902 is as described in step 302, which shall not be described herein any further.

It can be seen from the above embodiment that the UE needs not to measure RSRP of a signal transmitted by all points, but measures RSRP of a CSI-RS transmitted by each point in the RRM measurement set, thereby saving energy and avoiding waste of resources; and the primary serving base station of the UE may determine a downlink CoMP measurement set according to the RSRP after obtaining the reported RSRP, that is, selecting the points in the CoMP measurement set from the RRM measurement set, thereby solving the problems existed in the prior art.

FIG. 10 shows the apparatus for determining a downlink coordinated multipoint measurement set of Embodiment 7 of the present application. The apparatus may be a base station serving for UE, that is, a primary serving base station (eNB). As shown in FIG. 10, the apparatus includes: a receiving unit 1001 and a processing unit 1002, with their functions being similar to those of the receiving unit 901 and the processing unit 902 in Embodiment 6, which shall not be described herein any further.

In this embodiment, the apparatus needs to pre-configure CSI-RS resources for RRM measurement and notify the UE. Therefore, as shown in FIG. 10, the apparatus further includes: a first configuring unit 1103 and a first notifying unit 1004; wherein,

the first configuring unit 1003 is configured to, before receiving the reference signal receiving power reported by the UE, configure the UE with more than one groups of channel state information reference signal (CSI-RS) resources for measuring the reference signal receiving power of a CSI-RS transmitted by each point in the RRM measurement set;

and the first notifying unit 1004 is configured to notify the configured channel state information reference signal (CSI-RS) resources to the UE.

In this embodiment, parameters of the configured channel state information reference signal (CSI-RS) resources configured by the first configuring unit 1003 do not include a power ratio P_{c} of energy per-resource element of a downlink shared channel to energy per-resource element of the channel state reference signal, but include one or more of the following parameters: the number of antenna ports, a CSI-RS configuring parameter, and a subframe configuring parameter; wherein, details of each parameter are as described in embodiments 1 and 2, which shall not be described herein any further.

In this embodiment, after the processing unit 1002 determines the CoMP measurement set, the apparatus further configures CSI-RS resources for CSI measurement. Therefore, as shown in FIG. 10, the apparatus further includes: a second configuring unit 1005 and a second notifying unit 1006; wherein,

the second configuring unit 1005 is configured to, after the downlink coordinated multipoint measurement set is determined, configure the UE with one or more groups of channel state information reference signal (CSI-RS) resources for channel state information measurement;

and the second notifying unit 1006 is configured to notify the configured channel state information reference signal (CSI-RS) resources for channel state information measurement to the UE.

In this embodiment, parameters of the channel state information reference signal (CSI-RS) resources configured by the second configuring unit include one or more of the following parameters:

the number of antenna ports, a configuring parameter for determining resource elements occupied by the channel state information reference signal (CSI-RS), a subframe configuring parameter of the channel state information reference signal (CSI-RS), and a power ratio of energy per-resource element of a downlink shared channel to energy per-resource element of the channel state reference signal.

In an embodiment, the CSI-RS resources for the CSI measurement and the CSI-RS resources for the RRM measurement may be configured independently, that is, the channel state information reference signal (CSI-RS) resources for channel state information measurement configured by the second configuring unit 1005 are different from the channel state information reference signal (CSI-RS) resources for measuring the reference signal receiving power of each point in the RRM measurement set, and this case is similar to that in the embodiment shown in FIG. 6, which shall not be described herein any further.

In another embodiment, the CSI-RS resources for CSI measurement are not configured independently, but are selected from the CSI-RS resources for the RRM measurement. Therefore, the second configuring unit 1005 is configured to select the channel state information reference signal (CSI-RS) resources for channel state information measurement from the configured channel state information reference signal (CSI-RS) resources for measuring the reference signal receiving power of a channel state information reference signal transmitted by each point in the RRM measurement set;

and the second notifying unit 1006 is configured to notify the UE via signaling, such as semi-statically RRC signaling, or dynamic DCI signaling, e.g. bitmap signaling carried by high-layer RRC signaling, the selected channel state information reference signal (CSI-RS) resources for channel state information measurement, or the selected channel state information reference signal (CSI-RS) resources for channel state information measurement and corresponding parameters. This case is similar to that in the embodiment shown in FIG. 7, which shall not be described herein any further.

It can be seen from the above embodiment that the UE needs not to measure RSRP of a signal transmitted by all points, but measure RSRP of a CSI-RS transmitted by each point in the RRM measurement set, thereby saving energy and avoiding waste of resources; and the primary serving base station of the UE may determine a downlink CoMP measurement set according to the RSRP after obtaining the reported RSRP, that is, selecting the points in the CoMP measurement set from the RRM measurement set, thereby solving the problems existed in the prior art.

Furthermore, the CSI-RS resources for the CSI measurement and the CSI-RS resources for the RRM measurement may be configured independently, and the CSI-RS resources for measuring the CSI may be selected from the CSI-RS resources for the RRM measurement; and parameters of the configured CSI-RS resources for the RRM measurement are relatively few; furthermore, the network side may notify the configured resources and related parameters to the UE via bitmap signaling.

An embodiment of the present application further provides a computer-readable program, wherein when the program is executed in an apparatus for determining a downlink coordinated multipoint measurement set, the program enables the computer to carry out the method for determining a downlink coordinated multipoint measurement set as described in embodiments 1-4 in the apparatus for determining a downlink coordinated multipoint measurement set.

An embodiment of the present application further provides a storage medium in which a computer-readable program is stored, wherein the computer-readable program enables the computer to carry out the method for determining a downlink coordinated multipoint measurement set as described in embodiments 1-4 in an apparatus for determining a downlink coordinated multipoint measurement set.

The above apparatuses and methods of the present application may be implemented by hardware, or by hardware in combination with software. The present application relates to such a computer-readable program that when the program is executed by a logic device, the logic device is enabled to carry out the apparatus or components as described above, or to carry out the methods or steps as described above. The present application also relates to a storage medium for storing the above program, such as a hard disk, a floppy disk, a CD, a DVD, and a flash memory, etc.

The present application is described above with reference to particular embodiments. However, it should be understood by those skilled in the art that such a description is illustrative only, and not intended to limit the protection scope of the present application. Various variants and modifications may be made by those skilled in the art according to the spirits and principle of the present application, and such variants and modifications fall within the scope of the present application.

What is claimed is:

1. A method for determining a downlink coordinated multipoint measurement set, comprising:
receiving reference signal receiving power of a channel state information reference signal transmitted by each point in a radio resource management (RRM) measurement set reported by UE; wherein the reference signal receiving power of each point in the RRM measurement set is measured by the UE based on more than one groups of preconfigured channel state information reference signal resources; and
determining a downlink coordinated multipoint measurement set according to the reference signal receiving power reported by the UE.

2. The method according to claim 1, wherein before the step of receiving the reference signal receiving power reported by the UE, the method further comprises:
configuring the UE with more than one groups of channel state information reference signal resources for measuring the reference signal receiving power of a channel state information reference signal transmitted by each point in the RRM measurement set; and
notifying the configured channel state information reference signal resources to the UE.

3. The method according to claim 1, wherein parameters of the configured channel state information reference signal resources for measuring the reference signal receiving power of the channel state information reference signal transmitted by each point in the RRM measurement set do not include a power ratio of energy per-resource element of a downlink shared channel to energy per-resource element of the channel state information reference signal.

4. The method according to claim 1, wherein parameters of the configured channel state information reference signal resources for measuring the reference signal receiving power of a channel state information reference signal transmitted by each point in the RRM measurement set include one or more of the following parameters:
the number of antenna ports, a configuring parameter for determining resource elements occupied by the channel state information reference signal, and a subframe configuring parameter of the channel state information reference signal.

5. The method according to claim 1, wherein after the step of determining the downlink coordinated multipoint measurement set, the method further comprises:
configuring the UE with one or more groups of channel state information reference signal resources for channel state information measurement; and
notifying the configured channel state information reference signal resources for channel state information measurement to the UE.

6. The method according to claim 5, wherein parameters of the configured channel state information reference signal resources for channel state information measurement include one or more of the following parameters:
the number of antenna ports, a configuring parameter for determining resource elements occupied by the channel state information reference signal, a subframe configuring parameter of the channel state information reference signal, and a power ratio of energy per-resource element of a downlink shared channel to energy per-resource element of the channel state reference signal.

7. The method according to claim 5, wherein the channel state information reference signal resources for channel state information measurement and the channel state information reference signal resources for measuring the reference signal receiving power of a channel state information reference signal transmitted by each point in the RRM measurement set are configured independently.

8. The method according to claim 5, wherein the step of configuring the UE with one or more groups of channel state information reference signal resources for channel state information measurement comprises:
selecting the channel state information reference signal resources for channel state information measurement from the configured channel state information reference signal resources for measuring the reference signal receiving power of a channel state information reference signal transmitted by each point in the RRM measurement set;
and the step of notifying the configured channel state information reference signal resources for channel state information measurement to the UE comprises:
notifying to the UE via signaling, the selected channel state information reference signal resources for channel state information measurement, or the selected channel state information reference signal resources for channel state information measurement and corresponding parameters.

9. An apparatus for determining a downlink coordinated multipoint measurement set, comprising:
a receiving unit configured to receive reference signal receiving power of a channel state information reference signal transmitted by each point in a radio resource management (RRM) measurement set reported by UE; wherein the reference signal receiving power of each point in the RRM measurement set is measured by the UE based on more than one groups of preconfigured channel state information reference signal resources; and
a processing unit configured to determine a downlink coordinated multipoint measurement set according to the reference signal receiving power reported by the UE.

10. The apparatus according to claim 9, wherein the apparatus further comprises:
a first configuring unit configured to, before receiving the reference signal receiving power reported by the UE, configure the UE with more than one groups of channel state information reference signal resources for measuring the reference signal receiving power of a channel state information reference signal transmitted by each point in the RRM measurement set; and
a first notifying unit configured to notify the configured channel state information reference signal resources to the UE.

11. The apparatus according to claim 9, wherein parameters of the channel state information reference signal resources configured by the first configuring unit do not include a power ratio of energy per-resource element of a downlink shared channel to energy per-resource element of the channel state reference signal.

12. The apparatus according to claim 9, wherein parameters of the channel state information reference signal resources configured by the first configuring unit include one or more of the following parameters:
the number of antenna ports, a configuring parameter for determining resource elements occupied by the channel state information reference signal, and a subframe configuring parameter of the channel state information reference signal.

13. The apparatus according to claim 9, wherein the apparatus further comprises:
a second configuring unit configured to, after the downlink coordinated multipoint measurement set is determined, configure the UE with one or more groups of channel state information reference signal resources for channel state information measurement; and
a second notifying unit configured to notify the configured channel state information reference signal resources for channel state information measurement to the UE.

14. The apparatus according to claim 13, wherein parameters of the channel state information reference signal resources configured by the second configuring unit include one or more of the following parameters:
the number of antenna ports, a configuring parameter for determining resource elements occupied by the channel state information reference signal, a subframe configuring parameter of the channel state information reference signal, and a power ratio of energy per-resource element of a downlink shared channel to energy per-resource element of the channel state information reference signal.

15. The apparatus according to claim 13, wherein the channel state information reference signal resources for channel state information measurement configured by the second configuring unit are different from the channel state information reference signal resources for measuring the reference signal receiving power of each point in the RRM measurement set.

16. The apparatus according to claim 13, wherein the second configuring unit is configured to select the channel state information reference signal resources for channel state information measurement from the configured channel state information reference signal resources for measuring the reference signal receiving power of a channel state information reference signal transmitted by each point in the RRM measurement set;
and the second notifying unit is configured to notify the UE via signaling, the selected channel state information reference signal resources for channel state information measurement, or the selected channel state information reference signal resources for channel state information measurement and corresponding parameters.

17. An apparatus for determining a downlink coordinated multipoint measurement set, comprising:
a measuring unit configured to measure reference signal receiving power of a channel state information reference signal transmitted by each point in the RRM measurement set, via more than one groups of preconfigured channel state information reference signal resources, based on a channel state information reference signal; and
a reporting unit configured to report the measured reference signal receiving power to a primary serving base station.

18. The apparatus according to claim 17, wherein the apparatus further comprises:
a second receiving unit configured to receive more than one groups of configured channel state information reference signal resources for measuring the reference signal receiving power of a channel state information reference signal transmitted by each point in the RRM measurement set, and/or corresponding parameters, notified by a network side, or to receive one or more groups of configured channel state information reference signal resources for channel state information measurement, and/or corresponding parameters, notified by a network side.
